(19) United States
(12) Patent Application Publication
(10) Pub. No.: US 2025/0170645 A1
(43) Pub. Date: May 29, 2025

(54) PREPARATION SYSTEM WITH ROTARY VALVES FOR MAGNETIC PARTICLES FOR HEAVY METAL CONTAMINATION REDUCTION AND REMEDIATION OF CONTAMINATED FARMLAND SOIL

(71) Applicants: INSTITUTE OF SOIL SCIENCE, CAS, Nanjing City (CN); CHINA CONSTRUCTION EIGHTH ENGRG DIVISION CORP. LTD, Shanghai (CN)

(72) Inventors: Yongming LUO, Nanjing City (CN); Guoming LIU, Nanjing City (CN); Chen TU, Nanjing City (CN); Shuai YANG, Nanjing City (CN); Zhongyuan LI, Nanjing City (CN); Runlai LUO, Nanjing City (CN); Yifan QIN, Nanjing City (CN)

(21) Appl. No.: 18/960,433

(22) Filed: Nov. 26, 2024

(30) Foreign Application Priority Data
Nov. 28, 2023 (CN) 202311602412.8

(51) Int. Cl. B22F 9/08

(52) U.S. Cl. CPC B22F 9/08

(57) ABSTRACT

Provided is a preparation system with rotary valves for magnetic particles for heavy metal contamination reduction and remediation of contaminated farmland soil. A raw material modifying tank and a mixed liquid pre-stirring tank are respectively in communication with a mixed liquid preparation tank. The mixed liquid preparation tank, a mixed liquid degassing tank and a dropping device are serially connected in sequence. A magnetic particle solidification device is arranged below the dropping device. Rotary valve cavities, and a piston mounting seat with piston cavities are arranged inside a dropping seat body of the dropping device. The rotary valves are rotatably arranged in the rotary valve cavities. Material sucking pipes and material passing pipes axially perpendicular to the material sucking pipes are arranged inside each of the rotary valves. A dropping plate with feeding pipes and dropping holes are arranged below the rotary valve cavities.

### CROSS-REFERENCE TO RELATED APPLICATION

This patent application claims the benefit and priority of Chinese Patent Application No. 202311602412.8 filed with the China National Intellectual Property Administration on Nov. 28, 2023, the disclosure of which is incorporated by reference herein in its entirety as part of the present application.

### TECHNICAL FIELD

The present disclosure relates to the field of the preparation of soil contamination remediation materials, and in particular to a preparation system with rotary valves for magnetic particles for heavy metal contamination reduction and remediation of contaminated farmland soil.

### BACKGROUND

The contamination of heavy metal elements in soil is one of the soil environmental problems globally, which seriously threatens the quality and safety of agricultural products, human settlements, and ecological environment. Moreover, heavy metal contamination has the characteristics of high concealment, long duration and high harmfulness, making its removal relatively difficult.

At present, the remediation of heavy metal contaminated soil mainly refers to ensuring the quality and safety of agricultural products by reducing the bioavailablity of heavy metals. This is achieved through immobilization and stabilization techniques, planting low-accumulation crops, agronomic regulation, and other technologies that reduce the environmental risk posed by heavy metals. However, the reduction of the bioavailablity of heavy metals cannot reduce the content of heavy metals in the soil, which cannot fundamentally improve the quality of soil environment. Therefore, the development of heavy metal reduction remediation materials and related purification technologies is the key to overcoming the limitations of existing methods, enhancing the quality of soil environment, and ensuring the safety of agricultural products.

In the prior art, a variety of materials for heavy metal contamination reduction and remediation of soil have appeared, and with the development of technology, many materials for the remediation of heavy metal contaminated soil mostly appear in the form of magnetic particles. For example, in the patent No. CN112480930B, a magnetic soil remediation agent for heavy metal contaminated soil is provided. For the problem that there are many impurities in high-silicon aluminum raw materials such as coal fly ash, coal gangue and kaolin used in the prior art, magnetic Fe₃O₄ modified by tetraethoxysilane is used as a magnetic core, leaching residues of silicon-containing tailings after hydrothermal activation are used as a silicon source and an alkali source for synthesizing the shell of the remediation agent, and then the magnetic soil remediation agent with a core-shell structure is synthesized by using the hydrothermal method. For another example, in the patent No. CN112547029B, a microsphere composite material for the remediation of arsenic-containing water and heavy metal contaminated soil is provided. MnFe₂O₄ nanoparticles, after being prepared by a chemical coprecipitation method, are added into a mixed solution of chitosan and polyethylene glycol dialdehyde for reaction to obtain a mixture, then the mixture is dropped into an alkaline solution, and then the alkaline solution with the mixture is neutrality by deionized water to obtain the microsphere composite material. i.e., crosslinked chitosan loaded MnFe₂O₄.

However, in the prior art, the research and development of devices for preparing magnetic particles for soil remediation is insufficient, and the existing devices for preparing soil remediation agents generally have the disadvantages of small preparation amount, inability to achieve large-scale production, and the like. For example, in the patent No. CN114260309B, a device for preparing a remediation agent for soil remediation is provided. A solid quantitative dosing mechanism and a liquid quantitative dosing mechanism are mounted on a first material separation groove and a second material separation groove to facilitate workers to mix and prepare chemicals on the soil to be remediated in time. For another example, in the patent No. CN109807168B, a device for preparing a soil remediation agent is provided, primarily utilizing a carbonization chamber for material preparation. Neither of these devices is designed for the preparation of magnetic particles, and the output is small.

### SUMMARY

An objective of the present disclosure is to provide a preparation system with rotary valves for magnetic particles for heavy metal contamination reduction and remediation of contaminated farmland soil, which can improve the preparation efficiency of magnetic particles for contamination reduction and remediation of heavy metal contaminated soil, and can guarantee the preparation quality of the magnetic particles.

The objective of the present disclosure is achieved through the following technical solution.

A preparation system with rotary valves for magnetic particles for heavy metal contamination reduction and remediation of contaminated farmland soil, including a raw material modifying tank, a mixed liquid pre-stirring tank, a mixed liquid preparation tank, a mixed liquid degassing storage tank, a dropping device, and a magnetic particle solidification device, where an output port of the raw material modifying tank is in communication with a first feed inlet on the mixed liquid preparation tank, an output port of the mixed liquid pre-stirring tank is in communication with a second feed inlet on the mixed liquid preparation tank; the mixed liquid preparation tank, the mixed liquid degassing storage tank and the dropping device are serially connected in sequence; the magnetic particle solidification device is arranged below the dropping device; the dropping device includes a dropping storage chamber, a dropping seat body, and the rotary valves; the mixed liquid degassing storage tank is in communication with the dropping storage chamber, rotary valve cavities and a piston mounting seat are arranged inside the dropping seat body, and the rotary valves are rotatably arranged in the rotary valve cavities; material sucking pipes and material passing pipes axially perpendicular to the material sucking pipes are arranged inside each of the rotary valves; piston cavities are formed in the piston mounting seat, and liftable pistons are arranged in the piston cavities; a dropping plate is arranged below the rotary valve cavities, feeding pipes and dropping holes are arranged on the dropping plate in a staggered manner, and the feeding pipes are in communication with the dropping storage chamber; when the rotary valves are rotated to a suction position, lower ends of the material sucking pipes are respectively in communication with the feeding pipes, and upper ends of the material sucking pipes are respectively in communication with the piston cavities; and when the rotary valves are rotated to a dropping position, upper ends of the material passing pipes are respectively in communication with the piston cavities, and lower ends of the material passing pipes are respectively in communication with the dropping holes.

A first water delivery pipe and multiple feed ports are arranged on the raw material modifying tank, and each of a clay mineral A, a coupling agent and absolute ethyl alcohol is put into a corresponding one of the multiple feed ports, and a modifying stirring mechanism is arranged inside the raw material modifying tank.

A second water delivery pipe and multiple material inlets are arranged on the mixed liquid pre-stirring tank, and each of a clay mineral B, a magnetic particle material and a particle immobilizing material is put into a corresponding one of the material inlets, and a pre-stirring mechanism is arranged inside the mixed liquid pre-stirring tank.

A preparation stirring mechanism is arranged in the mixed liquid preparation tank, a degassing device and a degassing stirring mechanism are arranged in the mixed liquid degassing storage tank, and a vacuum pump is arranged at an upper end of the mixed liquid degassing storage tank.

An intermediate plate is arranged inside the dropping seat body, and the rotary valve cavities for accommodating the rotary valves are formed between the intermediate plate and the dropping plate, the piston mounting seat is fixedly arranged on an upper side of the intermediate plate, multiple connecting holes are formed in the intermediate plate, and each of the multiple connecting holes is in communication with a corresponding one of the piston cavities; each of the dropping holes on the dropping plate is coaxially aligned with a corresponding one of the multiple connecting holes, and each of the feeding pipes on the dropping plate is horizontally arranged at on an upper side of the dropping plate and axially perpendicular to an axial direction of the rotary valves.

The rotary valve cavities include multiple rows of rotary valve cavities, the multiple rows of rotary valve cavities are arranged in the dropping seat body, and each of the multiple rows of rotary valve cavities is internally provided with a corresponding one of the rotary valves; rotary valve motors are arranged outside the dropping seat body, and each row of the rotary valves is driven to rotate by a corresponding one of the rotary valve motors.

An upper end of each of the liftable pistons is connected to a piston connecting rod, and the piston connecting rod is driven to ascend and descend through a linear driving device.

The magnetic particle solidification device includes a first crosslinking reaction cavity, a second crosslinking reaction cavity, and a return pipe; a liftable overflow plate is arranged between the first crosslinking reaction cavity and the second crosslinking reaction cavity; an input end of the return pipe is in communication with the second crosslinking reaction cavity, an output end of the return pipe is in communication with the first crosslinking reaction cavity, and a reflux pump is arranged on the return pipe.

A liquid level detection device is arranged on an upper side of the first crosslinking reaction cavity, a rack, meshed with a gear, is arranged on a side of the overflow plate, and the gear is driven to rotate by a motor.

A first conveyor belt is arranged inside the second crosslinking reaction cavity, a magnetic particle cleaning device is arranged at an output side of the magnetic particle solidification device, a second conveyor belt is arranged below the magnetic particle cleaning device and is connected to the first conveyor belt, a magnetic particle drying device is arranged at an output side of the magnetic particle cleaning device, and a package system is arranged at an output side of the magnetic particle drying device.

The present disclosure has the advantages and positive effects as follows:
1. Raw materials, such as clay minerals, aluminosilicate minerals, magnetic materials and coupling agents, are pretreated by devices such as the raw material modifying tank, the mixed liquid pre-stirring tank, the mixed liquid preparation tank, mixed liquid degassing storage tank, etc. The raw material modifying tank, the mixed liquid pre-stirring tank and the mixed liquid preparation tank are used to mix and modify the raw materials, and the coupling agent and magnetic materials are uniformly loaded on the mineral surface through stirring control, thus improving the adsorption efficiency of heavy metal elements by subsequent composite materials. The mixed liquid degassing storage tank is used to remove residual bubbles in the mixed liquid, thus ensuring the smooth progress of subsequent processes and the quality of final magnetic particle products.
2. The dropping device can achieve the mass dropping production of magnetic particles, thus significantly improving the preparation efficiency of the magnetic particles. According to the dropping device provided by the present disclosure, the switching between a suction state and a dropping state of the device can be achieved through the rotary valve internally provided with the material sucking pipes and the material passing pipes. Moreover, the internal structure of the rotary valve and the operation control of the rotary valve are particularly simple. Multiple rows of rotary valves can be arranged in the dropping seat body as required, thereby further improving the dropping quantity and the dropping efficiency.
3. The dropping device can achieve the suction operation by means of the ascending and descending of the piston. Moreover, the amount of material sucked into the piston cavity can be controlled by controlling an ascending height of the piston, thus ensuring that the size of particles formed by subsequent dropping meets the requirements. Meanwhile, the synchronous ascending and descending of the pistons can ensure that the amount of material sucked into various piston cavities is the same, thus ensuring that the size of the particles formed by subsequent dropping is consistent, and ensuring the quality of finally formed magnetic particle products.
4. According to the magnetic particle solidification device provided by the present disclosure, two crosslinking reaction cavities are provided to ensure complete reaction and full solidification of the material particles, and meanwhile, the continuous dropping is not affected. Liquid drops dropped from the dropping device, after falling into the first crosslinking reaction cavity, instantly react with the crosslinking solution when making contact with the same, thus solidifying to form solid gel-like particles to precipitate. With the increase of material particles, the liquid level in the first crosslinking reaction cavity rises. When the liquid level reaches a set height, the overflow plate is lifted and opened, and the reflux pump is started. In this case, liquid circulation flow is formed between the first crosslinking reaction cavity and the second crosslinking reaction cavity, such that the particles at the bottom of the first crosslinking reaction cavity flow into the second crosslinking reaction cavity. Moreover, as the bottom of the second crosslinking reaction cavity is lower than that of the first crosslinking reaction cavity, more material particles can be accommodated in the second crosslinking reaction cavity, and the continuous dropping can be ensured while ensuring the complete reaction and full solidification of the material particles.

### BRIEF DESCRIPTION OF THE DRAWINGS

FIG. 1 is a structural diagram according to the present disclosure;

FIG. 2 is a structural diagram of a raw material modifying tank, a mixed liquid pre-stirring tank, a mixed liquid preparation tank and a mixed liquid degassing storage tank in FIG. 1;

FIG. 3 is a structural diagram of a dropping device, a magnetic particle solidification device, and a magnetic particle cleaning device in FIG. 1;

FIG. 4 is a front view of a dropping device in FIG. 3;

FIG. 5 is a schematic diagram of an internal structure of a dropping seat body in FIG. 4;

FIG. 6 is a three-dimensional diagram of a material sucking pipe and a material passing pipe in a rotary valve in FIG. 5;

FIG. 7 is a schematic diagram of the cooperation between a material sucking orifice of the material sucking pipe and a feeding pipe in FIG. 5;

FIG. 8 is a first schematic diagram of an operating state of the dropping seat body in FIG. 5;

FIG. 9 is a second schematic diagram of an operating state of the dropping seat body in FIG. 5;

FIG. 10 is a view along line A-A in FIG. 9; and

FIG. 11 is a structural diagram of a magnetic particle solidification device in FIG. 3.

In the drawings: 1 raw material modifying tank; 101 first feed device; 102 feed port; 103 modifying stirring mechanism; 104 output control valve; 105 first connecting pipeline; 2 mixed liquid pre-stirring tank; 201 second feed device; 202 third feed device; 203 pre-stirring mechanism; 204 second water delivery pipe; 2041 water delivery metering pump; 205 second connecting pipeline; 2051 mixed liquid metering pump; 3 mixed liquid preparation tank; 301 preparation stirring mechanism; 302 third connecting pipeline; 3021 check valve; 3022 material metering pump; 4 mixed liquid degassing storage tank; 401 degassing device; 402 vacuum pump; 403 degassing stirring mechanism; 5 dropping device; 501 dropping storage chamber; 502 dropping seat body; 503 piston; 5031 piston connecting rod; 504 piston mounting seat; 5041 piston cavity; 505 intermediate plate; 5051 connecting hole; 506 rotary valve; 5061 material sucking pipe; 50611 material sucking orifice; 50612 material discharge orifice; 5062 material passing pipe; 507 rotary valve motor; 508 dropping plate; 5081 feeding pipe; 5082 dropping hole; 6 magnetic particle solidification device; 601 first crosslinking reaction cavity; 602 second crosslinking reaction cavity; 603 overflow plate; 6031 rack; 6032 gear; 604 return pipe; 6041 reflux pump; 6042 return filter screen; 605 first conveyor belt; 7 magnetic particle cleaning device; 701 second conveyor belt; 8 magnetic particle drying device; 9 package system; 10 control system.

### DETAILED DESCRIPTION OF THE EMBODIMENTS

The present disclosure is further described in detail below with reference to accompanying drawings.

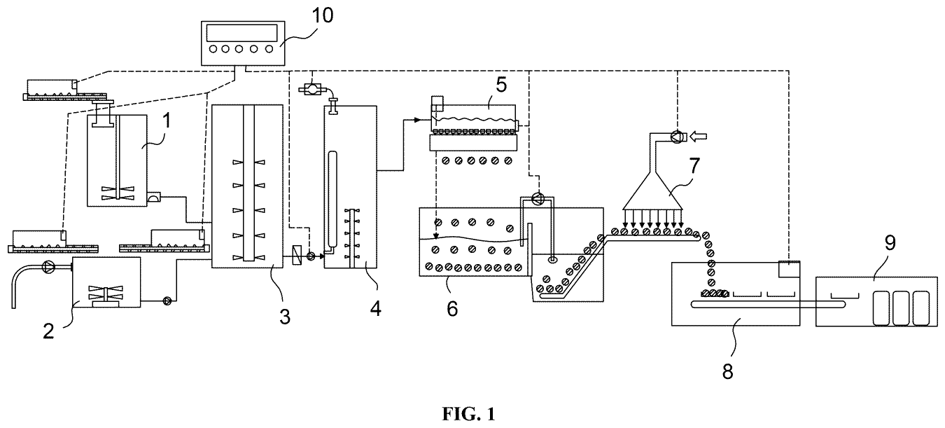

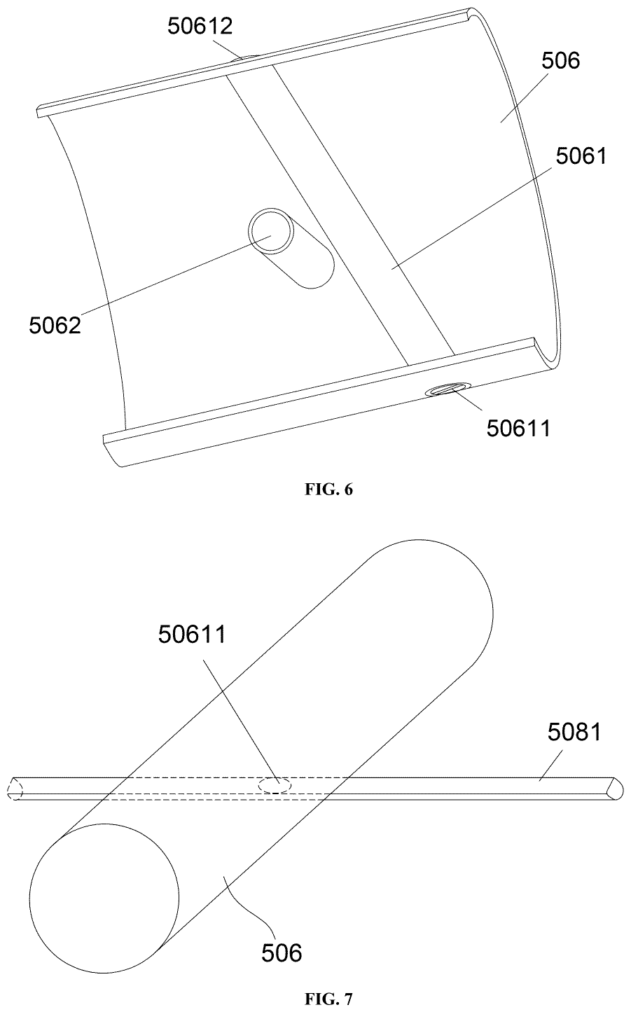

As shown in FIG. 1 to FIG. 11, the present disclosure includes a raw material modifying tank 1, a mixed liquid pre-stirring tank 2, a mixed liquid preparation tank 3, a mixed liquid degassing storage tank 4, a dropping device 5, and a magnetic particle solidification device 6. An output port of the raw material modifying tank 1 is in communication with a first feed inlet on the mixed liquid preparation tank 3 through a first connecting pipeline 105, and an output port of the mixed liquid pre-stirring tank 2 is in communication with a second feed inlet on the mixed liquid preparation tank 3 through a second connecting pipeline 205. The mixed liquid preparation tank 3, the mixed liquid degassing storage tank 4 and the dropping device 5 are serially connected in sequence. The magnetic particle solidification device 6 is arranged below the dropping device 5.

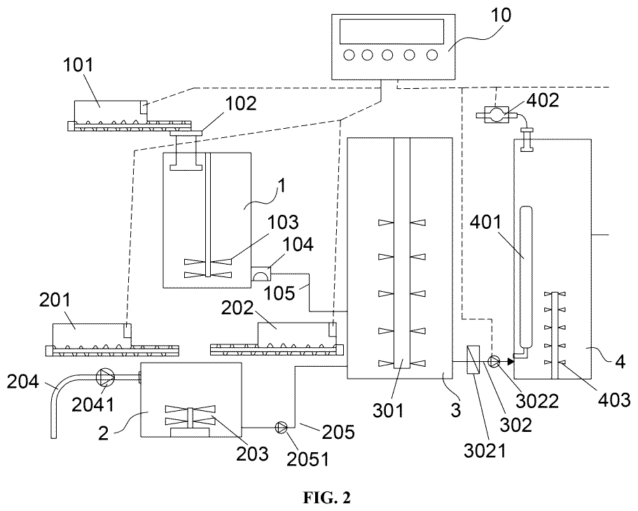

As shown in FIG. 2, in this embodiment, a first feed port 102, a second feed port, a third feed port, and a first water delivery pipe are arranged on the raw material modifying tank 1. A modifying stirring mechanism 103 is arranged inside the raw material modifying tank 1. A clay mineral A is put into the first feed port 102 under the driving of a first feed device 101, a coupling agent is put into the second feed port, and absolute ethyl alcohol is put into the third feed port. The first water delivery pipe is used to convey a set amount of distilled water into the raw material modifying tank 1, and the modifying stirring mechanism 103 is started such that the coupling agent is uniformly mixed and slowly loaded onto the surface of the clay mineral. In this embodiment, the first feed device 101 is a conveyor auger, which is a commercially available product. The modifying stirring mechanism 103 includes a stirring shaft, and a stirring motor. An upper end of the stirring shaft is arranged outside the raw material modifying tank 1 and is fixedly connected to the stirring motor, and a main body of the stirring shaft is arranged inside the raw material modifying tank 1 and provided with stirring blades. The feeding and stirring speed of the raw material modifying tank 1 can be controlled by a control system 10 according to actual needs.

As shown in FIG. 2, in this embodiment, a first material inlet, a second material inlet, a third material inlet, and a second water delivery pipe 204 are arranged on the mixed liquid pre-stirring tank 2. A pre-stirring mechanism 203 is arranged inside the mixed liquid pre-stirring tank 2. A clay mineral B is put into the first material inlet under the driving of a second feed device 201, a magnetic material is put into the second material inlet under the driving of a third feed device 202, and a particle immobilizing material is put into the third material inlet. The second water delivery pipe 204 is used to convey a set amount of distilled water into the mixed liquid pre-stirring tank 2, and then the pre-stirring mechanism 203 is started such that the clay mineral, the magnetic material and the particle immobilizing material are uniformly distributed in the mixed liquid to complete pre-stirring. In this embodiment, each of the second feed device 201 and the third feed device 202 is a conveyor auger. The pre-stirring mechanism 203 has the same structure as the modifying stirring mechanism 103, and the second feed device 201, the third feed device 202 and the pre-stirring mechanism 203 are all controlled by the control system 10.

As shown in FIG. 2, in this embodiment, each of the first water delivery pipe and the second water delivery pipe is provided with a water delivery metering pump 2041, and the water delivery metering pump 2041 is controlled by the control system 10.

As shown in FIG. 2, in this embodiment, a preparation stirring mechanism 301 is arranged inside the mixed liquid preparation tank 3. The material in the raw material modifying tank 1 enters the mixed liquid preparation tank 3 through a first connecting pipeline 105, and the material in the mixed liquid pre-stirring tank 2 enters the mixed liquid preparation tank 3 through a second connecting pipeline 205. Afterwards, the preparation stirring mechanism 301 is started such that various raw materials can be mixed for reaction. As a thickening additive in the raw material is diluted, the viscosity of the materials is further reduced. In this embodiment, the preparation stirring mechanism 301 has the same structure as the modifying stirring mechanism 103.

As shown in FIG. 2, in this embodiment, an output port of the raw material modifying tank 1 is provided with an output control valve 104 connected to the first connecting pipeline 105, and the second connecting pipeline 205 is provided with a mixed liquid metering pump 2051. In this embodiment, the output control valve 104 is a knife gate valve, which is a commercially available product. The output control valve 104 and the mixed liquid metering pump 205 are both controlled by the control system 10.

As shown in FIG. 2, in this embodiment, the material in the mixed liquid preparation tank 3 enters the mixed liquid degassing storage tank 4 through a third connecting pipeline 302, the third connecting pipeline 302 is provided with a check valve 3021, and a material metering pump 3022, and the material metering pump 3022 is controlled by the control system 10. A degassing device 401 and a degassing stirring mechanism 403 are arranged in the mixed liquid degassing storage tank 4. An upper end of the mixed liquid degassing storage tank 4 is provided with a vacuum pump 402 for vacuumizing the interior of the mixed liquid degassing storage tank 4. The material in the mixed liquid preparation tank 3 enters the mixed liquid degassing storage tank 4 under the driving of the material metering pump 3022, and then the degassing stirring mechanism 403 is started to stir the material, the degassing device 401 is started to remove the air dissolved in the stirring process, thus preventing residual bubbles from damaging the material structure in the subsequent solidification process. The material metering pump 3022, the degassing device 401, the degassing stirring mechanism 403 and the vacuum pump 402 are all controlled by the control system 10. In addition, in this embodiment, the degassing stirring mechanism 403 has the same structure as the modifying stirring mechanism 103. The degassing device 401 can remove bubbles in the material using generated high-frequency ultrasonic waves, which is a well-known technique in the art. For example, an ultrasonic bubble removal device is provided in the Chinese utility model patent with the authorization announcement number of CN214971938U, the cavitation of ultrasonic waves is limited in transfer liquid inside a telescopic vibrating membrane, and the telescopic vibrating membrane is vibrated by ultrasonic energy to extrude and fracture bubbles in the fluid to achieve the purpose of removing bubbles. The degassing device 401 may also a mature product purchased in the market.

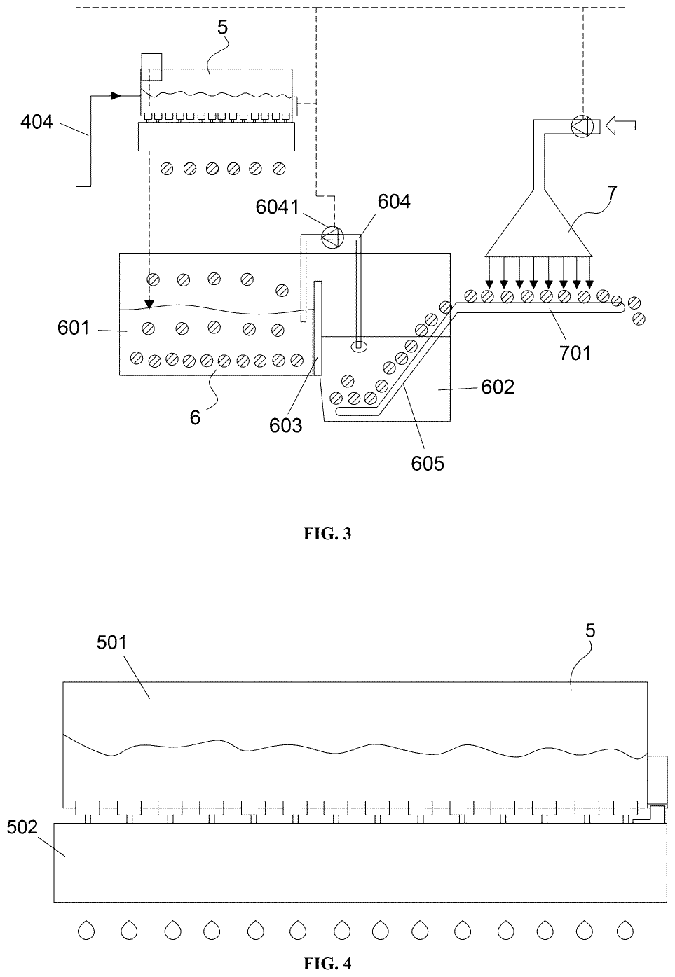

As shown in FIG. 3, in this embodiment, the mixed liquid degassing storage tank 4 is connected to the dropping device 5 through a fourth pipeline 404, and a dropping metering pump is arranged on the fourth pipeline 404. The material degassed in the mixed liquid degassing storage tank 4 enters the dropping device 5 under the action of a dropping metering pump, and the dropping metering pump is controlled by the control system 10.

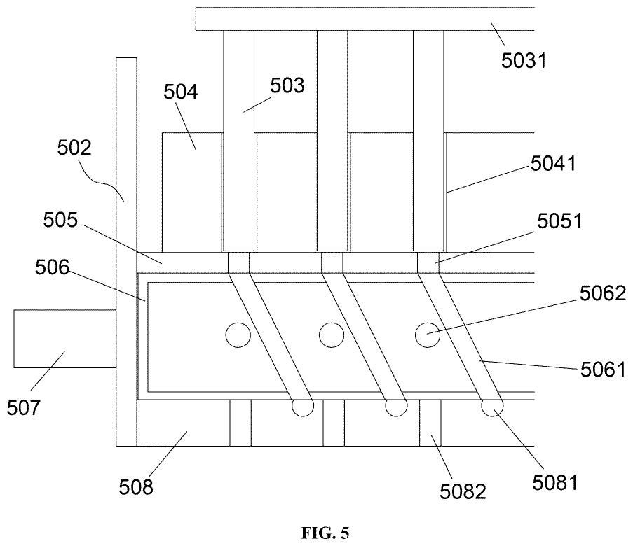

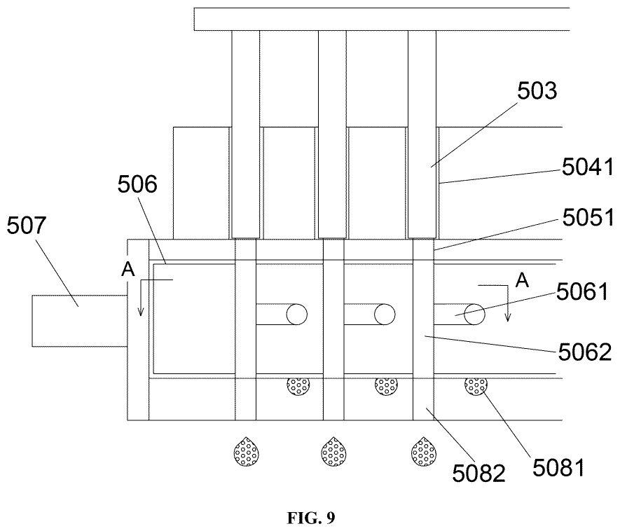

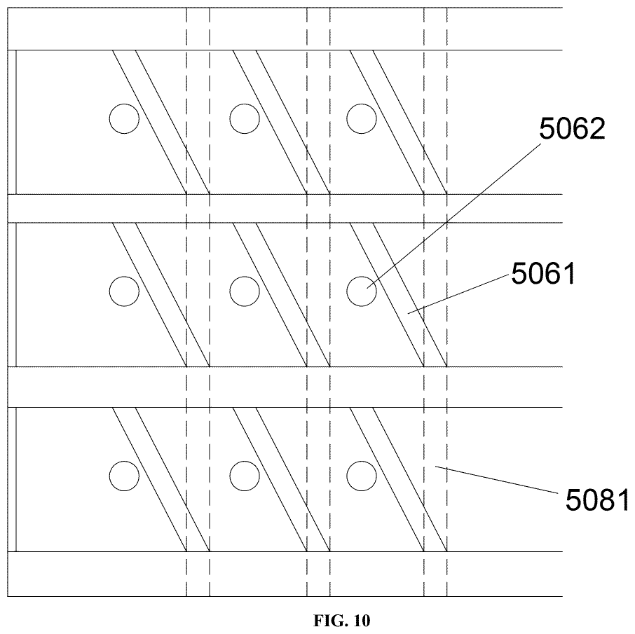

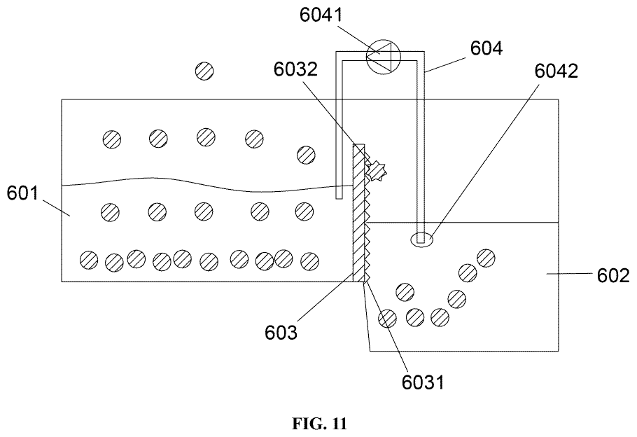

As shown in FIG. 4 to FIG. 10, in this embodiment, the dropping device 5 includes a dropping storage chamber 501, a dropping seat body 502, and rotary valves 506. The mixed liquid degassing storage tank 4 is in communication with the dropping storage chamber 501 through the fourth pipeline 404, and the dropping seat body 502 is arranged below the dropping storage chamber 501. As shown in FIG. 5, in this embodiment, a piston mounting seat 504, an intermediate plate 505, and a dropping plate 508 are arranged inside the dropping seat body 502; and rotary vale cavities are formed between the intermediate plate 505 and the dropping plate 508. The rotary valves 506 are rotatably arranged in the rotary valve cavities. The piston mounting seat 504 is fixedly arranged on an upper side of the intermediate plate 505, multiple piston cavities 5041 are formed in the piston mounting seat 504, and liftable pistons 503 are arranged in the piston cavities 5041. Multiple connecting holes 5051 are formed in the intermediate plate 505, and each connecting hole 5051 is in communication with a corresponding piston cavity 5041. Material sucking pipes 5061 and material passing pipes 5062 axially perpendicular to the material sucking pipes 5061 are arranged inside the rotary valve 506. Feeding pipes 5081 and dropping holes 5082 are arranged on the dropping plate 508 in a staggered manner. The feeding pipes 5081 are horizontally arranged at an upper side of the dropping plate 508 and axially perpendicular to an axial direction of the rotary valves 506, and each dropping hole 5082 is coaxially aligned with the corresponding connecting hole 5051 and has the same aperture as the corresponding connecting hole. As shown in FIG. 5 to FIG. 8, when the rotary valve 506 is rotated to a suction position, a material sucking orifice 50611 at a lower end of the material sucking pipe 5061 is in communication with a corresponding feeding pipe 5081, and a material discharge orifice 50612 at an upper end of the material sucking pipe 5061 is in communication with a corresponding connecting hole 5051, and in this case, the material passing pipe 5062 is rotated to a horizontal position, and there is no material passing through. As shown in FIG. 9 to FIG. 10, when the rotary valve 506 is rotated to a dropping position, a material inlet at the upper end of the material passing pipe 5062 is in communication with the corresponding connecting hole 5051, a material outlet at a lower end of the material passing pipe 5062 is in communication with a corresponding dropping hole 5082, and in this time, the material sucking pipe 5061 is rotated to a horizontal piston. The intermediate plate 505 and the dropping plate 508 can be integrally formed with side plates on both sides of the dropping seat body 502 by means of molds, etc. In addition, the intermediate plate 505 and the dropping plate 508 may also be made into an integral cylindrical shape to fit the rotary valve 506 according to actual needs, or can be made into a separate structure for easy disassembly.

As shown in FIG. 4 to FIG. 10, in this embodiment, an outer side of the dropping seat body 502 is provided with rotary valve motors 507, and each of the rotary valves 506 is driven to rotate by a corresponding rotary valve motor 507.

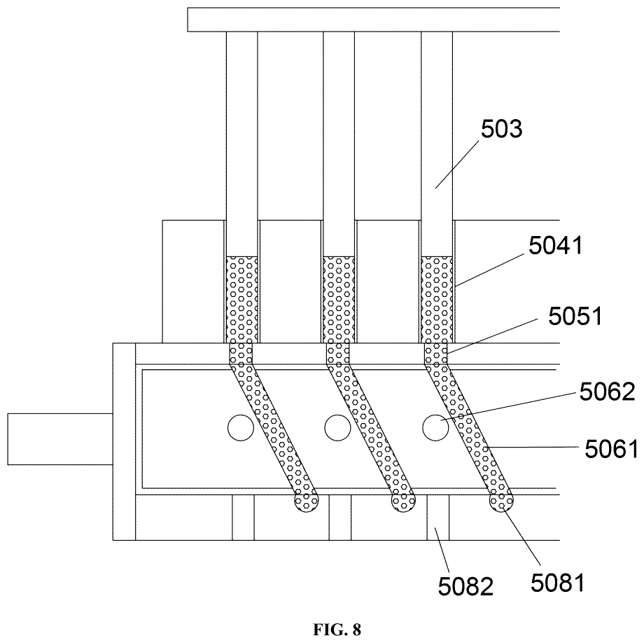

As shown in FIG. 4 to FIG. 10, in this embodiment, an upper end of each piston 503 is connected to one piston connecting rod 5031, and the piston connecting rod 5031 is driven to ascend and descend through a linear driving device such as a cylinder, or an electric push rod, thus driving each piston 503 to ascend and descend synchronously. As shown in FIG. 8, when the piston 503 ascends, the material in the corresponding feeding pipe 5081 is sucked into the piston cavity 5041 through a corresponding material sucking pipe 5061. Moreover, the ascending height of the piston connecting rod 5031 can be controlled according to the size of the prepared particles, that is, the ascending height of each piston 503 is controlled. Therefore, on the one hand, the amount of the material sucked into the piston cavities 5041 can be controlled to ensure that the size of the particles formed by final dropping meets the requirements. On the other hand, the synchronous ascending and descending of various pistons 503 may also ensure the consistency of the sucked materials in the piston cavities 5041, thus ensuring the consistency of the final magnetic particle product size. As shown in FIG. 9, after the piston 503 ascends in place, the rotary valve 506 is rotated to make both ends of the material passing pipe 5062 therein respectively communicate with the corresponding piston cavity 5041 (through the corresponding connecting hole 5051) and the dropping hole 5082. After the piston 503 descends, the material in the piston cavity 5041 is extruded out, and the material enters the corresponding dropping hole 5082 through the connecting hole 5051 and the material passing pipe 5062 in sequence and then drops into the magnetic particle solidification device 6. In addition, the rotary valve motor 507 needs to be controlled by the control system to operate in conjunction with a driving device (e.g., an air cylinder, an electric cylinder or a servo motor) that moves the piston 503, thus ensuring that when the rotary valve 506 is rotated to the suction position, that is, when the material sucking pipe 5061 communicates with the piston cavity 5041, the piston 503 moves upwards to suck the material; when the rotary valve 506 is rotated to the material passing pipe 5062 to communicate with the piston cavity 5041, the piston 503 moves downwards to remove liquid materials, thus forming dropping process, the above processes are repeated for continuous operation.

As shown in FIG. 10, multiple rows of rotary valve cavities can be arranged inside the dropping seat body 502 as required, the rotary valve 506 is arranged in each rotary valve cavity, thus further improving the material dropping efficiency. In this embodiment, multiple vertical partitions can be arranged in the space between the intermediate plate 505 and the dropping plate 508 to form multiple rotary valve cavities. Moreover, the feeding pipes 5081 run through the whole dropping plate 508, and thus each material sucking pipe 5061 in each rotary valve 506 may communicate with the corresponding feeding pipe 5081 to suck the material. In addition, either end of the feeding pipe 5081 may communicate with the dropping storage chamber 501 above the dropping seat body 502 through a material inlet pipeline. The material inlet pipeline may be provided with a metering pump and other devices as required to ensure that each feeding pipe 5081 is filled with the material, a situation that the material in a certain part of the feed pipe 5081 is insufficient to cause insufficient material absorption after the piston 503 is lifted is avoided, this is well known in the art.

As shown in FIG. 11, in this embodiment, the magnetic particle solidification device 6 includes a first crosslinking reaction cavity 601, a second crosslinking reaction cavity 602, and a return pipe 604. A liftable overflow plate 603 is arranged between the first crosslinking reaction cavity 601 and the second crosslinking reaction cavity 602. An input end of the return pipe 604 is in communication with the second crosslinking reaction cavity 602, an output end of the return pipe 604 is in communication with the first crosslinking reaction cavity 601, and a reflux pump 6041 is arranged on the return pipe 604. In this embodiment, CaCl₂ solution is used as a crosslinking solution, and each of the first crosslinking reaction cavity 601 and the second crosslinking reaction cavity 602 is internally provided with the crosslinking solution. Liquid drops dropped from the dropping device 5, after falling into the first crosslinking reaction cavity 601, instantly react with the crosslinking solution when making contact with the same, thus solidifying to form solid gel-like particles to precipitate. With the increase of material particles, the liquid level in the first crosslinking reaction cavity 601 rises. When a liquid level detection device detects the liquid level in the first crosslinking reaction cavity 601 reaches a set height, the overflow plate 603 is lifted and opened, and the reflux pump 6041 is started. In this case, the liquid at the bottom of the first crosslinking reaction cavity 601 drives the material particles to flow to the second crosslinking reaction cavity 602, while the crosslinking solution in the second crosslinking reaction cavity 602 flows into the first crosslinking reaction cavity 601, thus forming liquid circulation flow. As the bottom of the second crosslinking reaction cavity 602 is lower than that of the first crosslinking reaction cavity 601, more material particles can be accommodated in the second crosslinking reaction cavity 602. The continuous dropping will not be affected while ensuring the complete reaction and full solidification of the material particles. A first conveyor belt 605 is arranged inside the second crosslinking reaction cavity 602, through which the solidified material particles are output to enter the next process. In addition, as shown in FIG. 11, an input end of the return pipe 604 is provided with a return filter screen 6042 to prevent the material particles from being sucked back. The liquid level detection device is a well-known technique in the art, and a commercially available product, such as a liquid level detection sensor.

As shown in FIG. 11, in this embodiment, a rack 6031 meshed with a gear 6032 is arranged on a side of the overflow plate 603, and the gear 6032 is driven to rotate by the motor, thus making the overflow plate 603 ascend and descend.

As shown in FIG. 1, in this embodiment, a magnetic particle cleaning device 7 is arranged at an output side of the magnetic particle solidification device 6. A second conveyor belt 701 is arranged below the magnetic particle cleaning device 7 and is connected to the first conveyor belt 605 arranged inside the second crosslinking reaction cavity 602. A lower side of the magnetic particle cleaning device 7 is provided with multiple spray header for spraying cleaning water to remove the residual crosslinking reagent solution on the surface of the material particles, thus preventing the crosslinking reagent solution from damaging the material itself in the subsequent process. The cleaned material particles fall into a magnetic particle drying device 8 for drying to remove moisture. In this embodiment, the magnetic particle drying device 8 is a set of microwave drying system, and the dried material particles finally enter a package system 9 for packaging. The magnetic particle cleaning device 7, the magnetic particle drying device 8 and the package system 9 are all well known in the art and commercially available products.

In addition, as shown in FIG. 1, the driving device and detection element of each portion of the present disclosure are controlled by the control system 10.

An operation principle of the present disclosure is as follows.

In an application example of the present disclosure, the clay mineral A is powdered attapulgite, the clay mineral B is zeolite, the magnetic material is magnetic ferroferric oxide powder, or magnetic iron slag powder, magnetic reduced iron slag powder, etc., the coupling agent may be one of silane coupling agents, such as 3 mercaptopropyl triethoxysilane (KH-580), or other silane coupling agents with organic functional groups (such as KH-540, KH-550, KH-560, etc.); and the particle immobilizing material is sodium alginate which is a natural polymeric substance. In the present disclosure, the sodium alginate solution (which has a certain viscosity) and calcium ions are subjected to crosslinking reaction to form magnetic composite particle pellets, which are dried to obtain magnetic particles for metal contamination reduction and remediation of contaminated farmland soil.

The specific process flow of the application example is as follows.

2.0 kg attapulgite powder (80-300 meshes) is used as the clay mineral A to be put into the raw material modifying tank 1, and 40.3 L softened water is added into the raw material modifying tank 1 through the first water delivery pipe, then the modifying stirring mechanism 103 is started. Afterwards, 860 mL absolute ethyl alcohol and 489 mL silane coupling agent are added into the raw material modifying tank 1 to start a material modifying reaction. The modification time is set at 2.5 hours. Meanwhile, 129 L softened water is added into the mixed liquid pre-stirring tank 2 through the second water delivery pipe 204, 2.0 kg sodium alginate powder is slowly added into the mixed liquid pre-stirring tank 2 through the second feed device 201 (for example, at a rate of 120 g/min), and the pre-stirring mechanism 203 is synchronously started to prevent the sodium alginate from caking when added into water. After the sodium alginate is completely dissolved to form a sodium alginate solution with viscosity, 1.0 kg zeolite powder is added into the mixed liquid pre-stirring tank 2 as the clay mineral B through the third feed device 202, and 2.0 kg ferroferric oxide powder is added into the mixed liquid pre-stirring tank 2 as the magnetic material. After the above materials are fed, the pre-stirring mechanism 203 continues to stir until the mixed liquid with uniform mixing properties is obtained.

After the raw material modification and the mixed liquid pre-stirring are completed, the materials in the raw material modifying tank 1 and the mixed liquid pre-stirring tank 2 are pumped into the mixed liquid preparation tank 3, respectively. The preparation stirring mechanism 301 is started to stir until the materials are completely mixed. Afterwards, the materials are conveyed to the mixed liquid degassing storage tank 4 to remove residual bubbles from the mixed liquid and complete the pretreatment of the raw materials.

The materials in the mixed liquid degassing storage tank 4, after bubble removal is completed, enter the dropping device 5 for dropping operation. As shown in FIG. 5 to FIG. 8, when the rotary valve 506 in the dropping seat body 502 is rotated to a suction position, a material sucking orifice 50611 at a lower end of the material sucking pipe 5061 in the rotary valve 506 is in communication with the corresponding feeding pipe 5081, and a material discharge orifice 5062 at an upper end of the material sucking pipe 5061 is in communication with the corresponding connecting hole 5051, and then various pistons 503 ascend synchronously to suck the material in the corresponding feeding pipe 5081 into the corresponding piston cavity 5041 through the corresponding material sucking pipe 5061. Moreover, the ascending height of the piston connecting rod 5031 can be controlled according to the size of the prepared particles, i.e., the ascending height of each piston 503 can be controlled, such that the material sucked into the piston cavity 5041 is finally dropped to form particles with the size meeting the requirements. Synchronous ascending and descending of the pistons 503 can ensure that the amount of the material sucked into the piston cavities 5041 are consistent, and the size consistency of subsequent magnetic particle products is ensured. After the piston 503 ascends in place, as shown in FIG. 9, when the rotary valve 506 is rotated to a dropping position, the material inlet at the upper end of the material passing pipe 5062 is in communication with the corresponding connecting hole 5051, and a material outlet at the lower end of the material passing pipe 5062 is in communication with the corresponding dropping hole 5082, then the piston 503 descends to extrude out the material in the piston cavity 5041 completely. The material enters the corresponding dropping hole 5082 through the corresponding connecting hole 5051 and material passing pipe 5062 in sequence and drops into the magnetic particle solidification device 6.

As shown in FIG. 11, liquid drops dropped from the dropping device 5, after falling into the first crosslinking reaction cavity 601 of the magnetic particle solidification device 6, instantly react with the crosslinking solution (CaCl₂ solution) when making contact with the same, thus solidifying to form solid gel-like particles to precipitate. With the increase of material particles, the liquid level in the first crosslinking reaction cavity 601 rises. When a liquid level detection device detects the liquid level in the first crosslinking reaction cavity 601 reaches a set height, the overflow plate 603 is lifted and opened, and the reflux pump 6041 is started. In this case, the liquid at the bottom of the first crosslinking reaction cavity 601 drives the material particles to flow to the second crosslinking reaction cavity 602, while the crosslinking solution in the second crosslinking reaction cavity 602 flows into the first crosslinking reaction cavity 601, thus forming liquid circulation flow. As the bottom of the second crosslinking reaction cavity 602 is lower than that of the first crosslinking reaction cavity 601, more material particles can be accommodated in the second crosslinking reaction cavity 602. The continuous dropping will not be affected while ensuring the complete reaction and full solidification of the material particles.

The first conveyor belt 605 is arranged inside the second crosslinking reaction cavity 602, the solidified material particles are output by the first conveyor belt 605 to enter the second conveyor belt 701 below the magnetic particle cleaning device 7 for cleaning by spraying, thus removing the residual cross-linking reagent solution on the surface of the material particles. Afterwards, the material particles fall into the magnetic particle drying device 8 for drying, thus removing moisture. The dried material particles finally enter the package system 9 for packaging.

What is claimed is:

1. A preparation system with rotary valves for magnetic particles for heavy metal contamination reduction and remediation of contaminated farmland soil, comprising a raw material modifying tank (1), a mixed liquid pre-stirring tank (2), a mixed liquid preparation tank (3), a mixed liquid degassing storage tank (4), a dropping device (5), and a magnetic particle solidification device (6),
wherein an output port of the raw material modifying tank (1) is in communication with a first feed inlet on the mixed liquid preparation tank (3), an output port of the mixed liquid pre-stirring tank (2) is in communication with a second feed inlet on the mixed liquid preparation tank (3); the mixed liquid preparation tank (3), the mixed liquid degassing storage tank (4) and the dropping device (5) are serially connected in sequence; the magnetic particle solidification device (6) is arranged below the dropping device (5), and the dropping device (5) comprises a dropping storage chamber (501), a dropping seat body (502), and the rotary valves (506); the mixed liquid degassing storage tank (4) is in communication with the dropping storage chamber (501), rotary valve cavities and a piston mounting seat (504) are arranged inside the dropping seat body (502), and the rotary valves (506) are rotatably arranged in the rotary valve cavities; material sucking pipes (5061) and material passing pipes (5062) axially perpendicular to the material sucking pipes (5061) are arranged inside each of the rotary valves (506); piston cavities (5041) are formed in the piston mounting seat (504), and liftable pistons (503) are arranged in the piston cavities (5041); a dropping plate (508) is arranged below the rotary valve cavities, feeding pipes (5081) and dropping holes (5082) are arranged on the dropping plate (508) in a staggered manner, and the feeding pipes (5081) are in communication with the dropping storage chamber (501); when the rotary valves (506) are rotated to a suction position, lower ends of the material sucking pipes (5061) are respectively in communication with the feeding pipes (5081), and upper ends of the material sucking pipes (5061) are respectively in communication with the piston cavities (5041); and when the rotary valves (506) are rotated to a dropping position, upper ends of the material passing pipes (5062) are respectively in communication with the piston cavities (5041), and lower ends of the material passing pipes (5062) are respectively in communication with the dropping holes (5082).

2. The preparation system with the rotary valves for magnetic particles for heavy metal contamination reduction and remediation of contaminated farmland soil according to claim 1, wherein a first water delivery pipe and a plurality of feed ports are arranged on the raw material modifying tank (1), and each of a clay mineral A, a coupling agent and absolute ethyl alcohol is put into a corresponding one of the plurality of feed ports, and a modifying stirring mechanism (103) is arranged inside the raw material modifying tank (1).

3. The preparation system with the rotary valves for magnetic particles for heavy metal contamination reduction and remediation of contaminated farmland soil according to claim 1, wherein a second water delivery pipe (204) and a plurality of material inlets are arranged on the mixed liquid pre-stirring tank (2), and each of a clay mineral B, a magnetic particle material and a particle immobilizing material is put into a corresponding one of the material inlets, and a pre-stirring mechanism (103) is arranged inside the mixed liquid pre-stirring tank (2).

4. The preparation system with the rotary valves for magnetic particles for heavy metal contamination reduction and remediation of contaminated farmland soil according to claim 1, wherein a preparation stirring mechanism (301) is arranged in the mixed liquid preparation tank (3), a degassing device (401) and a degassing stirring mechanism (403) are arranged in the mixed liquid degassing storage tank (4), and a vacuum pump (402) is arranged at an upper end of the mixed liquid degassing storage tank (4).

5. The preparation system with the rotary valves for magnetic particles for heavy metal contamination reduction and remediation of contaminated farmland soil according to claim 1, wherein an intermediate plate (505) is arranged inside the dropping seat body (502), and the rotary valve cavities for accommodating the rotary valves (506) are formed between the intermediate plate (505) and the dropping plate (508), the piston mounting seat (504) is fixedly arranged on an upper side of the intermediate plate (505), a plurality of connecting holes (5051) are formed in the intermediate plate (505), and each of the plurality of connecting holes (5051) is in communication with a corresponding one of the piston cavities (5041); each of the dropping holes (5082) on the dropping plate (508) is coaxially aligned with a corresponding one of the plurality of connecting holes (5051), and each of the feeding pipes (5081) on the dropping plate (508) is horizontally arranged at on an upper side of the dropping plate (508) and axially perpendicular to an axial direction of the rotary valves (506).

6. The preparation system with the rotary valves for magnetic particles for heavy metal contamination reduction and remediation of contaminated farmland soil according to claim 1, wherein the rotary valve cavities comprises a plurality of rows of rotary valve cavities, the plurality of rows of rotary valve cavities are arranged in the dropping seat body (502), and each of the plurality of rows of rotary valve cavities is internally provided with a corresponding one of the rotary valves (506); rotary valve motors (507) are arranged outside the dropping seat body (502), and each of the rotary valves (506) is driven to rotate by a corresponding one of the rotary valve motors (507).

7. The preparation system with the rotary valves for magnetic particles for heavy metal contamination reduction and remediation of contaminated farmland soil according to claim 1, wherein an upper end of each of the liftable pistons (503) is connected to a piston connecting rod (5031), and the piston connecting rod (5031) is driven to ascend and descend through a linear driving device.

8. The preparation system with the rotary valves for magnetic particles for heavy metal contamination reduction and remediation of contaminated farmland soil according to claim 1, wherein the magnetic particle solidification device (6) comprises a first crosslinking reaction cavity (601), a second crosslinking reaction cavity (602), and a return pipe (604); a liftable overflow plate (603) is arranged between the first crosslinking reaction cavity (601) and the second crosslinking reaction cavity (602); an input end of the return pipe (604) is in communication with the second crosslinking reaction cavity (602), an output end of the return pipe (604) is in communication with the first crosslinking reaction cavity (601), and a reflux pump (6041) is arranged on the return pipe (604).

9. The preparation system with the rotary valves for magnetic particles for heavy metal contamination reduction and remediation of contaminated farmland soil according to claim 8, wherein a liquid level detection device is arranged on an upper side of the first crosslinking reaction cavity (601), a rack (6031), meshed with a gear (6032), is arranged on a side of the overflow plate (603), and the gear (6032) is driven to rotate by a motor.

10. The preparation system with the rotary valves for magnetic particles for heavy metal contamination reduction and remediation of contaminated farmland soil according to claim 8, wherein a first conveyor belt (605) is arranged inside the second crosslinking reaction cavity (602), a magnetic particle cleaning device (7) is arranged at an output side of the magnetic particle solidification device (6), a second conveyor belt (701) is arranged below the magnetic particle cleaning device (7) and is connected to the first conveyor belt (605), a magnetic particle drying device (8) is arranged at an output side of the magnetic particle cleaning device (7), and a package system (9) is arranged at an output side of the magnetic particle drying device (8).

11. The preparation system with the rotary valves for magnetic particles for heavy metal contamination reduction and remediation of contaminated farmland soil according to claim 5, wherein the rotary valve cavities comprises a plurality of rows of rotary valve cavities, the plurality of rows of rotary valve cavities are arranged in the dropping seat body (502), and each of the plurality of rows of rotary valve cavities is internally provided with a corresponding one of the rotary valves (506); rotary valve motors (507) are arranged outside the dropping seat body (502), and each of the rotary valves (506) is driven to rotate by a corresponding one of the rotary valve motors (507).
